(19) United States
(12) Patent Application Publication
(10) Pub. No.: US 2011/0044792 A1
(43) Pub. Date: Feb. 24, 2011

(54) Facility And Method For Interment And Automated Retrieval Of Interred Subjects

(76) Inventors: Paul A. Talley, Coral Springs, FL (US); Anthony V. Pugliese, III, Delray Beach, FL (US)

Correspondence Address: Bruce D. George, Esquire;Blank Rome LLP, One Logan Square, Philadelphia, PA, 19103, US

(21) Appl. No.: 12/822,890

(22) Filed: Jun. 24, 2010

Related U.S. Application Data
(63) Continuation-in-part of application No. 12/690,746, filed on Jan. 20, 2010.
Application No. 12/690,746 is a continuation of application No. 11/512,401, filed on Aug. 30, 2006, now abandoned.
(60) Provisional application No. 60/712,679, filed on Aug. 30, 2005.
(60) Provisional application No. 61/219,878, filed on Jun. 24, 2009.

(51) Int. Cl. E04H 13/00; B65G 1/06

(52) U.S. Cl. 414/807; 52/133

(57) ABSTRACT

An interment method and facility for interment and automated retrieval and visitation of interred subjects. The facility includes an interment area for holding the interred subjects, at least one visitation area for visitor access to a selected one of the interred subjects, a system retrieval mechanism for transporting the selected interred subject between the interment area and the visitation area, and a facility management system providing automated control of interment, visitation, and transport therebetween. Identification information for, and a location of, the interred subjects held in the interment area are recorded. A sensory system reads identification information associated with each interred subject, monitoring location and orientation. A request is received by a visitor, as programmed into a facility management system, for visitation of a selected interred subject. The selected interred subject is retrieved, by a system retrieval mechanism, from the interment area, and is transported to a visitation area.

### RELATED APPLICATIONS

This application claims benefit of U.S. Provisional Application Ser. No. 61/219,878, filed Jun. 24, 2009, entitled “A Facility and Method for Interment and Automated Retrieval of Interred Subjects.” This application is a continuation-in-part of U.S. application Ser. No. 12/690,746, filed Jan. 20, 2010, entitled “Automated Self-Storage System;” which application is a continuation of U.S. application Ser. No. 11/512,401, filed Aug. 30, 2006; which application claims benefit of U.S. Provisional Application Ser. No. 60/712,679, filed Aug. 30, 2005. The above-identified related applications are incorporated herein by reference.

### BACKGROUND OF THE INVENTION

The loss of a loved one is a traumatic experience which only dissipates with time and healthy grieving. Most traumatic in this loss, is the separation and finality of known pleasures and memories which were shared with the departed. A typical cemetery or mausoleum give a finite ending to the relationship with the departed and terminate all of the memories which are built over the time shared with the departed. These traditional ending places do not permit continued remembrances of shared moments and events. At best, seasonal (and most commonly artificial) flowers, pictures and other quickly removed mementos, are all that can be shared. Recently, the availability of video and audio devices have allowed recorded scenes to be accessible at a cemetery or mausoleum. For example, U.S. Pat. No. 7,287,225 describes monuments which includes audio and video components. Other non-traditional interment facilities have been created but these are not convenient for visitors nor do they make economic sense or use land efficiently while appreciating conservation, for example U.S. Pat. No. 6,261,028.

In a typical cemetery or mausoleum, interred subjects are provided with a permanent, exclusive marker or a location having an exterior surface (stone or wall block), accessible via passageways and corridors provided for visitation. Because of the need to access each interred subject individually, a large portion of the facility is consumed by access passageways, and moreover, the facility corridors and passageways must be sufficiently large to provide convenient access; this consumes significant amounts of interment facility space. Because of this inefficient use of space, most particularly in a mausoleum situation, an interred subject is usually stacked behind a wall five or six levels vertically and twelve horizontally, forming an imposing sterile atmosphere. Therefore, a mourner visiting a loved one would be required to stand at the base of the wall of unknown names which can be as much as forty feet high and fifty feet wide. Further, it is common for a mourner to be visiting a loved one who is at a height well above eye level, or at ankle level causing further trauma.

Thus, there is a need in the industry to allow the interred subject to be retrieved and brought to the mourner for visitation with the departed in a setting that is peaceful, comfortable and private to the mourner, and one that ensures respectful and secure treatment of the interred subject while being transported to and from the visitation setting.

### SUMMARY OF THE INVENTION

The present invention also allows for substantially increased interment area on a substantially reduced facility footprint. By eliminating the need for inter facility passageways and multiple access to interred individuals, the system of the present invention allows for reduced facility costs and increased land use density allowing for increased facility height while maintaining easy access at ground level.

In operations, a lease for the interred subject is obtained for the facility. Various contractual methods are possible, however, it will be appreciated that at a designated time period the interred subject will be relocated to a permanent traditional resting place. This is based on two reasons; 1) after a number of years family members and mourners may no longer visit; and 2) a permanent place may ensure respect and tranquility for the interred subject and the mourners of the interred subject. For example, a contractual agreement may exist with the facility of the present invention for 100 years, and thereafter the interred subject is directed to a permanent resting place or cremation.

In a first embodiment the present invention is directed to an eternal view interment system for automated retrieval and visitation of interred subjects. The system includes an interment facility and an integrated software system which allows for the interment and retrieval of the interred subject. In addition, the system includes at least one visitation area; and at least one double interred subject visitation area thereby allowing multiple interred subjects to be “visited” simultaneously (e.g. a mother and father). The at least one visitation area and the at least one double interred subject visitation area each have a first door which is traversed by mourners and a second door which is traversed by the interred subject from the interment facility, for visitation.

Variation and combinations of facility designs are possible while keeping within the goals and spirit of the invention. In an exemplary first embodiment, there is a plurality of visitation areas each accessible by the public. These plurality of visitation areas can be accessible from a separate visitor entrance, thus allowing close proximity of the mourners to the interred individual retrieved from the interment area (as discussed below). In combination, the plurality of visitation areas are not accessible from a separate visitor entrance. The visitation areas which are not accessible by the public are for automated programmed retrieval of an individual to a designated visitation area which 1) overlooks a scenic part of the grounds of the facility without having mourner physically there or 2) for video visits when a mourner can not physically be at the facility (e.g. they are a great distance away or cannot travel to the facility). A variety of video equipment and arrangements can be used as recognized by those of skill in the art and therefore do not have to be described herein.

The ability to have a “remote” visit, or the advantage of a system that can retrieve the interred subject to the visitation areas on a scheduled basis, such as weekly or monthly, allows loved ones to take comfort in knowing that the interred subject is in an environment of pleasant and natural surroundings. This would eliminate the undesired thoughts of loved ones being “in the ground” or “in the wall” for eternity, and replaces those thoughts with the knowledge that a loved one is (in a defined way) participating.

The visitation areas allow for the interred subject to be reunited in body with the grieving mourners, wherein the reunion can be in a “manufactured setting” which was once shared. Specifically, the system of the present invention allows the mourner to retrieve the interred subject for visitation in a visitation area based on memories shared (e.g., an area setting of a family room which includes a television “to share” the watching of a sporting event). This can be done if the mourner is physically at the facility with the interred subject, or is having a “remote” visit. Thus, a mourner can continually re-unite the interred subject with a setting appreciated by the departed during their lifetime, whether or not the mourner can physically be with the interred individual.

The facility of the system can be divided into a main interment area having a series of associated interment bays and at least one visitation area for visitation by the mourner. Each interred subject can be interred in a bay wherein a central control system maintains a record of which bay each interred subject is located.

The facility management system (FMS) can be accessed via an electronic access panel (EAP) in a visitation area, such as a key pad or other electronic interface device, or a series of both, or by other entry security systems or devices known in the art. Most commonly, the mourner is given a code or an access card or other means of secure access. Each mourner enters an assigned pass code, or swipes a pass card, or otherwise activates a secure access system. This information is then sent to the facility management system which is constantly updating and storing information such as payments, frequency of visits, and habits (e.g., when particular mourners access a particular interred subject; the amount of time a mourner maintains the interred subject at a visitation area; and/or the amount of time between visits by particular mourners). This information is processed and used to manage the storage positions (locations) of all the interred subjects in the facility. Additionally, the identification and fiduciary information of the interred subject is stored within the FMS for operation of the facility.

An automation system retrieves the interred subject, or more specifically, a supporting means for the interred subject. The supporting means can be in many forms, but most commonly is in the form of a table or palette. The support means that holds the interred subjects can be built of a variety of materials, including aluminum, or of any component capable of meeting structural requirements necessary to carry the weight set by industry standards. The interred subject is releasably secured to the support means, thereby allowing the interred subject to be transferred to another facility if desired at a later time. Most importantly, handling of the supporting means, rather than the casket of the interred subject, ensures greater stability, and therefore, serenity of the interred subject.

In the main interment area of the facility, the interred subjects are placed on a support means or palette, and are located within a manufactured steel wall system which includes the plurality of interment bays designed for this application (as discussed). Each interment bay is braced at the top with cross braces to keep the interred subjects aligned for easy transport. Each interment bay in the wall system has rails on the bottom for the support means or palette of each interred subject to rest on. Depending on the configuration of the facility, these interment bays may be six positions deep (side to side) for maximum efficiency. On the top of the interment positions, attached to the braces, is a fire sprinkler system designed for interment.

If the interred subject becomes skewed in an interment bay, the subject will be returned to the loading position, and the FMS will notify the attendant. Specifically, there is a set of inferred beams from various locations throughout the facility that “review” the interred subject on the support means to ensure that it is straight and square before and after it is taken from the interment bay. This ensures that the subject has not shifted or leaned in the bay, causing improper stacking, and will not collide with the frame when the interred subject is in transport.

The configuration of the facility, while generally standardized, can be custom designed for any site requirement. The wall system holding the interred subjects is engineered for its intended purpose based on weight requirements and is coordinated with required systems (e.g., scanning and tracking systems (as discussed herein)). The facility is constructed with a grid of steel columns spaced for the configuration of the interred subjects. The wall system is self supporting and open throughout. The building shell and roof may be braced to the wall system if needed for lateral support or the wall system can be completely independent.

A track system is configured for transporting the interred subjects. The track system allows movement in multiple directions, both horizontally and vertically, throughout the facility and the visitation areas. Specifically, the track system includes an unobstructed railway through the center of the facility. The railway can be depressed in a slab, so that delivery of an interred subject is at floor level. A turn-table, proximal to the railway, can be used to rotate the interred subject (if necessary) for proper orientation in the visitation area.

The location of each interred subject can be tracked throughout the interment facility by a computer tracking system that maintains information regarding the present and historic location of the interred subjects. Any of a number of location tracking systems, including barcodes, scan tags, passive transponders, infrared tags, RF tags and the like, could be used. The tracking system maintains the location of each interred subject so that the mechanism used to retrieve and transport the interred subject efficiently knows from where to retrieve the interred subject.

As the interred subject moves through the facility, the tracking system monitors the interred subject by a moving mechanism (as well as any other location verification system which tracks subject movement through the facility). Because the system tracks the location of interred subjects throughout the facility, it is not necessary to return the interred subject to the identical interment bay location form which it originally came. This tracking allows the FMS to store the interred subject in a most desirable available space. The most desirable available space may be the first (closest) available space, or it may be an available space located elsewhere in the facility, and deemed desirable based upon one or more factors discussed herein.

A crane of the handling system runs from end to end of the track system to retrieve interred subjects from a bay located in any position and at any height within the facility. The crane can be controlled by an automated system. The crane also has an operator station for service and emergency operations. The automation system of the present invention provides efficient handling, interment and retrieval of the interred subject in the interment facility.

The one or more visitation areas are preferably completely enclosed and isolated from the main interment area. In the enclosed visitation area there are a series of sensors that perform checks before bringing the interred subject back into the main interment area. These include motion sensors, alignment scanners checking that the interred subject was not altered during loading, infrared scanners ensuring that nothing entered the casket of the interred subject, and potentially other biologic detectors. Additionally, motion sensors attached to the interred subject can also monitor shifts in loads during transport and/or while the interred subject is in interment. The detection of a load shift can then be reported to the system control for action.

The one or more visitation areas of the interment facility can have a first door for access by the mourners of the facility, and a second door for access to the interment area of the facility. In one embodiment, only one of the two doors can be open at any one time, thereby preventing access by the mourners to the interior of the interment facility. In this embodiment, mourner access door(s) remain closed until the interred subject being moved is in position in the visitation area. More specifically, in this embodiment, the second (interment facility) door is opened and the interred subject moves into the visitation area, then the second door is closed. The first (mourner access) door can then open, allowing entry and viewing by the mourner, in the visitation area, while preventing mourner access to other interred subjects. Once the first door is closed, and a mourner has exited the visitation area at the completion of a visit, the second door can be opened to allow the interred subject to transported back into the main portion of the interment facility. Control of the opening and closing of the doors would be by the management control system.

The FMS can be a standard warehouse management system integrated with the central control system to thereby perform tasks and maintenance necessary for interment. These systems allow access to the interred subject, position and retrieval interment history for maintenance, positioning for placement in the wall system, average time needed once the interred subject is visited, and weight limits in place for the size of the interred subject.

In another embodiment, the present invention is directed to a method for visitation of an interred subject. In practice, the mourner enters identifying information for the interred subject desired to be accessed together with a form of authentication into the FMS via the EAP. If authentication is valid, the FMS system coordinates with the control system to search its memory for the location of the interred individual. Upon receiving the information from the control system, the FMS forwards the information to the automation system which sends a handling system to the associated bay and retrieves the interred subject for transport to a designated visitation area.

The interred subject is retrieved from its interment location by a crane which loads the desired interred subject onto a railway, via the support means, and is then moved along railway, by trolley, until it reaches the desired junction railway. The selection of the desired junction railway is based upon the destination of the interred subject and the orientation of interred subject. If the interred subject must first be rotated, it will switch off the railway for proper orientation. The selected railway will again depend on the visitation area selected by the mourner.

When the interred subject is traveling to the visitation area(s), the second door will open to allow interred subject to enter a visitation area. Once the interred subject is in visitation area, the second door will close and thereafter, the first door will open allowing access by the mourner(s) to the visitation area.

Another entry to the EAP interface device returns the interred subject to an unoccupied bay. When the mourner has completed his visit with the interred subject, he enters his code, or other security access method, into the EAP for return to the system. At that time the FMS will perform a series of safety checks. For example, the FMS could check for movement within the enclosure of the interred subject, for heat or other scan and detection methods, and for security and integrity of the interred subject. Once that is complete and “OK”, the FMS will return the interred subject “in a reverse” fashion by the handling system, as discussed herein. If there is a problem with the safety checks, the problem can be resolved by staff personnel, and cleared for return to the system.

In another embodiment, the present invention relates to a facility designed and built to inter and provide automated retrieval for visitation of interred subjects, as well as a sanctuary for the development of avian life which includes an interment facility with at least one visitation area and an avian habitat facility.

The system of the present invention, as described in greater detail below, has many novel aspects, including the ability to move interred subjects within a facility without human assistance. One conceptual focus is convenience in mourning while efficiently using land resources. Another focus is the security and integrity of the interred subject. For example, discretion of a grave marker by weather, the environment and vandals are eliminated by the present invention.

### BRIEF DESCRIPTION OF THE DRAWINGS

For a better understanding of the nature of the present invention, reference is made to the following figures and detailed description, wherein like elements are accorded like reference numerals, and wherein:

FIG. 1 is a top plan view of an exemplary layout for an interment facility according to one embodiment of the present invention;

FIG. 2 is a block floor plan diagram of an alternative layout for an interment facility according to another embodiment for the present invention; and

FIG. 3 is an exemplary end elevation view of the facility illustrated in either FIG. 1 or 2, illustrating four levels of stacked interment containers in an interment area, and a visitation area and/or avian habitat facility.

### DETAILED DESCRIPTION OF EXEMPLARY EMBODIMENTS

In a first embodiment the present invention provides an eternal view interment facility and method for automated retrieval and visitation of interred subjects. The facility includes an interment area and an integrated software system that allows for the interment and retrieval of interred subjects. In addition, the facility includes at least one visitation area; and can include at least one double interred subject visitation area, thereby allowing multiple interred subjects to be “visited” simultaneously (e.g. a deceased mother and father visited by still living children). The at least one visitation area and the at least one double interred subject visitation area each have a first door which is traversed by mourners and a second door which is traversed by the interred subject(s) from the interment area for visitation.

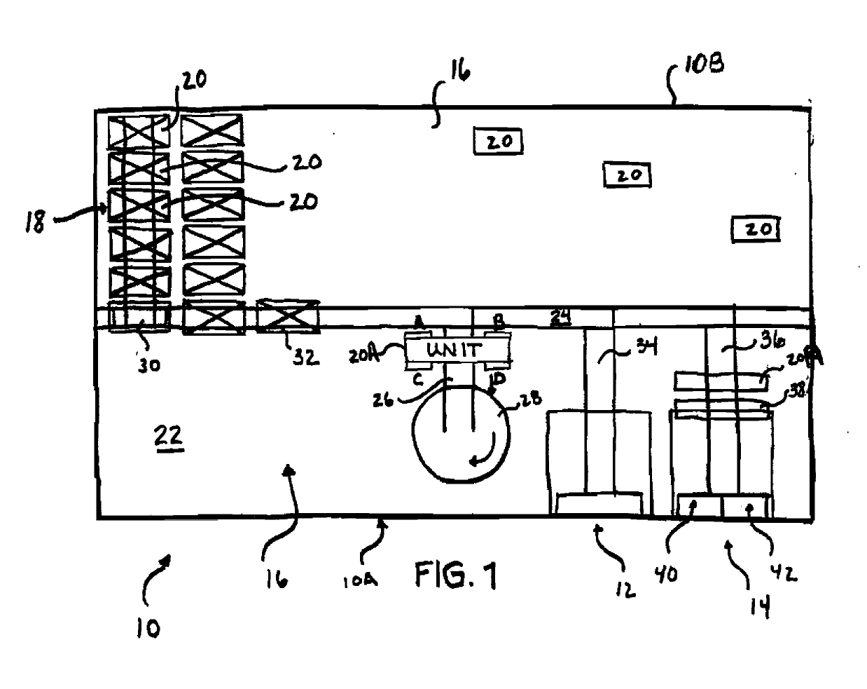

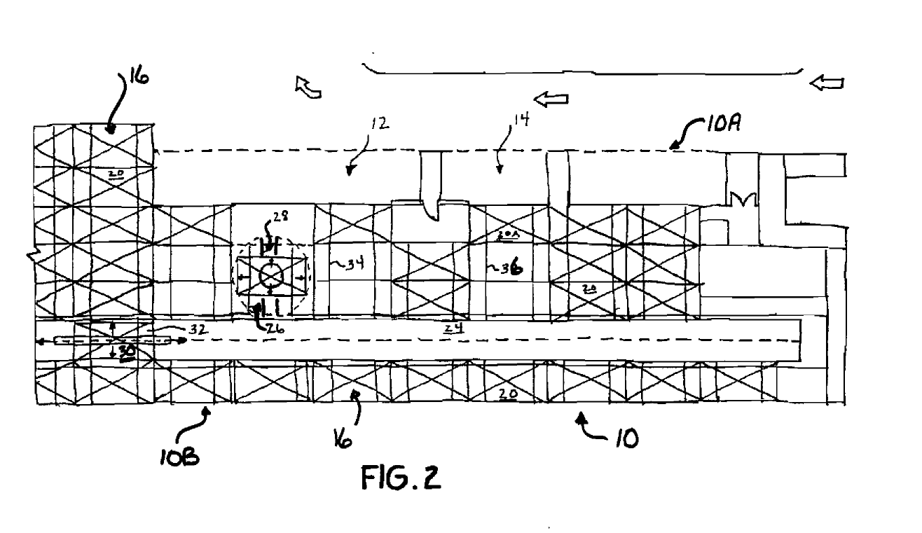

As illustrated in FIGS. 1 and 2, the overall facility 10 includes visitation areas 12 and 14 at the first of the facility 10A and interment area 16 at the second of the facility 10B. Exemplary interment (bay) locations 18 are shown at the left side of FIG. 1. Illustrated in second interment areas or locations 16 are interred subjects 20. Interred subjects 20 can be interred throughout the facility 10 in rows similar to those illustrated in the exemplary interment bays 18. Not all locations for interred subjects are illustrated, but are understood. In FIG. 1, the left side 22 of the first of the facility 10A can also be used for interment or for additional visitation areas.

In the exemplary layout illustrated in FIGS. 1 and/or 2, an interred subject 20 is shown being moved through the facility 10. Interred subject 20 has been moved from main railway 24 to the rotation interred subject railway 26 so that the interred subject 20 can be moved onto turntable 28 to change the orientation of interred subject 20, if desired. Orientation is based upon sensor readings from sensors located along the main railway 24.

The turntable 28 serves three functions: 1) orients caskets such that the desired end (i.e. desired direction of casket) is presented to a visitor in a visitation area; 2) squares (balances) the caskets so they are correctly positioned over a palette; and 3) provides staff with casket access for interred subjects newly entered into the facility. The orienting and squaring functions are described below:

Before the enclosure of the interred subject 20 can be placed on the railway 24, the interred subject 20 must be retrieved from its interment bay (location) 18 by crane 30. Crane 30 loads the desired interred subject 20 onto railway 24, where the interred subject 20 is then moved along the railway 24 by a trolley 32. The trolley 32 transports the interred subject 20 along the railway 24 until reaching a desired junction railway. The selection of the desired junction railway is based upon a programmed destination of the interred subject 20, and the orientation of interred subject 20 as retrieved from the interment bays 18.

If the enclosure (casket) of the interred subject 20 requires a change of orientation (i.e., rotation), then the interred subject 20 will exit the main railway 24 at the rotation interred subject railway 26. If the interred subject 20 does not require rotation for proper orientation, the respective trolley 32 will proceed to a visitation area railway 34, 36. The selected visitation area railway 34, 36 will again depend on the visitation area 12, 14 selected by the mourner, and/or availability of respective visitation areas.

By way of further example, once a interred subject 20A is traveling to the visitation areas 12, 14, as illustrated in FIG. 1, a second (interment) door 38 will open to allow the interred subject 20A to enter the visitation area 14. Once the interred subject 20A is in the visitation area 14, a first (visitor) door 40, 42 will open, allowing access to the visitation area 14 by the visitor(s) (or mourner(s)). In one embodiment, note that there is a very close fit between the enclosure of interred subject 20A and the frame of the second (interment) door 38, thereby preventing access by the visitor to the interior of the interment area 16. Thus, in this embodiment, the interred subject 20A can be positioned to act as a “seal” for any attempted access through the second (interment) door 38 when an interred subject 20A and visitors reside in the visitation area 12, 14.

The visitation area 12, 14 can be of a variety of designs to ensure security and integrity of the interred subject 20 (e.g., separating the interred subject 20 from the visitors, in the visitation area 12, 14, by glass to keep the casket of interred subject 20 in a controlled atmosphere and environment). The various designs and concerns for the visitation area 12, 14 are within the knowledge of those skilled in the art for the mechanical requirements, and decorative aspects, for enclosures of interred subjects, while remaining within the concept of the present invention.

As illustrated in FIGS. 1 and 2, the crane 30 may include a satellite projection (not shown) to reach down the rows and remove interred subjects 20 one at a time until the desired interred subject is accessible. The crane 30 will re-store the undesignated interred subjects 20 in other available interment bays 18 of the facility 10. The locations of the re-positioned, undesignated interred subjects 20 will be maintained (tracked and stored) by the FMS. In this manner, the interred subjects 20 which had been moved to provide access to a designated interred subject 20, need not be re-located to their original location after retrieval of the designated interred subject 20.

If other interred subjects are stacked between the retrieval passageway and the desired interred subject, those interred subjects are first moved out of position by the handling device so that the desired interred subject can be accessed. The interred subjects are moved to the isle position for pick up by the handling system which may include, for example, a crane with a satellite that is attached to the crane.

The configuration of the system, while generally standardized, can be custom designed for the requirements of any given site. The frame that holds the enclosures of the interred subjects is engineered for its intended purpose. It is constructed with a grid of steel columns spaced for the configuration of the interred subjects, with beams to carry the interred subjects to the desired height. This frame is self-supporting and is open throughout. There is bracing, as needed, in accordance with pre-engineered design. The building shell and roof may be braced to the frame, if needed for lateral support, or the frame can be completely independent from building shell and/or roof structure.

Each interred subject can include a number of identity tags, at locations on and about the enclosure of the interred subject, so that not only the interred subject, but also the orientation of the interred subject, can be determined and tracked by the FMS upon retrieval from the interment bays, and upon movement through the facility. Because each of the tags is coded differently, the FMS (by detecting the specific code on, and location of, each tag) can determine the orientation of the interred subject when located in an interment bay, and when moving upon railway through the facility. It is possible to determine and track the orientation and movement of each interred subject with a single tag; however, additional tag detection devices may be employed because, depending upon the orientation of the interred subject, different sides of the interred subject pass by different portions of the facility (and thereby pass by different scanning device locations). It will be recognized that by placing a separately coded tag on each of the four corners of the enclosure of the interred subject, fewer detection devices need be employed in the facility to determine and track the orientation of an interred subject throughout the facility.

In addition to tracking the orientation of an interred subject for desired presentation to a visitor, tracking the orientation of the interred subject can help to identify and control proper balancing for “stacking”. Multiple detection devices provide for location confirmation redundancy and failsafe measures in the event of a single detection device failure. Further, when the FMS is performing routine maintenance, the system can update the respective position of each interred subject in interment.

The FMS not only tracks the orientation and location of interred subjects in real time, but also stores this information for later use. By storing location and movement information about the individual interred subjects, the FMS can maintain a history of interred subject movement and a history of mourner visitation. The FMS can learn from this information and develop parameters for more efficient interment placement, based upon interred subject movement, orientation history, and the present information of interred subject locations. For example, the system can track, determine and report concerning the most frequently accessed interred subjects and the most recent mourners. The FMS can use this information to select an interment location for each interred subject that makes sense relative to the frequency of request for access of each interred subject. For example, the most frequently (or most recently) accessed interred subjects can be placed on the outside locations (i.e., close to the main railway 24), while less frequently accessed interred subjects may be stored farther back, or deep in the interment bays (i.e., farther from the main railway 24). However, because the FMS can have the capacity to learn, through inclusion of an expert system, the system may make location decisions different from the examples herein provided.

The control system of the FMS of the present invention will learn many things about the interment and access habits of the average mourner. For example, frequency of access is typically greatest soon after an interred subject is first interred. Frequency of access usually decreases after a first period of time. The control system will learn the typical frequency of access and the typical “reduction of visitation” curve for the typical interred subject, and therefore will interpret this information to establish geographic location in the interment facility for the interred subject, and moreover, the demographics of the mourners for a particular interred subject. The system will then use this information to make more efficient interment placement decisions for interred subjects.

The facility is provided with fire safety and suppression systems. These systems include fire doors which are also sealed insulated doors, so that the interior of the interment area can be climate controlled for long term interment. The facility also has a sprinkler system which, when a fire is detected in a particular area of the facility, can localize fire suppression to that particular area, thereby decreasing possible water damage during extinguishment of the fire.

In addition to the sensors/detectors described above, the system also incorporates a series of movement and/or orientation detectors to detect any swaying in the system. In addition to the balance sensors mentioned above, inertia or momentum sensors are incorporated to detect swaying. In an exemplary embodiment, sway sensors are employed to control these factors. Sway can be maintained within certain parameters to ensure the integrity of the system.

Further details concerning design and operation of the bays, wall system, railways, a subject retrieval mechanism, including trolleys, crane, satellite, and turntable, a facility management system, including sensory system, control system, tracking system and automation control, can be found in U.S. application Ser. No. 12/690,746, filed Jan. 20, 2010, entitled Automated Self-Storage System (US Pub. No. 2010/0121481). U.S. application Ser. No. 12/690,746, by the inventors of the present application, is incorporated herein by reference.

In another embodiment, the present invention is directed to a method for interment and retrieval of an interred subject in a facility having at least one visitation area and the at least one double interred subject visitation area and a main interment area.

Initially, the deceased will be brought to the interment facility and deposited as an interred subject at the main interment area. This can be done at the time of burial or later, if transferred from another facility. In either situation, the interred subject will be assigned an identification information, providing location capability of the interred subject at all times. The identification information can take the form of alphanumeric identifiers, can utilize a multiple part identifier, and/or can employ a tag or barcode and be used in conjunction with the tracking system previously described.

Upon attaching the identification information, it is coordinated with a common identification code for a fiduciary of the interred subject. The fiduciary will most likely be a “family” code which will be distributed at the time of interment. This could be a set of numbers and letters for use with the EAP for visitation; for example, the last name of the deceased followed by the date of their death. Further, the EAP could work with a “swipe card” system wherein the information is “read” directly from the card. Once the interred subject has the attached identification tag or barcode, and these are coordinated with the fiduciary (or family) information, the interred subject is transferred to an identifiable portion of the main interment area, wherein an interred subject is interred under the control of a control system. At this point, the interred subject is “interred” in the main interment area as discussed herein, and rests.

When visitors and/or mourners arrive to visit the interred subject, they communicate the interred subject identification code and visitation area to which the interred subject is requested to be retrieved for visitation. As discussed herein, the retrieval of the interred subject is initiated by the integrated software system of the interment facility, as initiated by the mourners implementing their identification code into the EAP system. Thereafter, the interred subject is transported from the interment area to the communicated visitation area via the track system.

By way of example, the method could include the following:

### Example 1

When a customer (visitor) arrives, they will identify themselves at the main entrance. If their credentials are acceptable, the customer's account is up to date, and there is an available viewing area, the main gate will open and allow the customer access into the interior area of the complex. If the customer's credentials are incorrect, do not match those stored within the FMS, the following message can be provided: The credentials entered are incorrect. Please re-enter them or see the attendant for assistance. If the customer's account is past due the following message will be provided: Please see attendant for assistance concerning your account. Upon access into the complex, the customer will walk to an open viewing station and again enter their credentials using the EAP located adjacent to a door. If the credentials are incorrect, do not match those stored within the FMS, the following message will be provided: The credentials that were entered are incorrect. Please re-enter them or see the attendant for assistance. If the customer's credentials are accepted, a request is initiated to move the casket. The casket may have been pre-staged if the customer scheduled an appointment. The FMS will instruct a system retrieval mechanism (SRM) to retrieve the selected casket of the interred subject, and place it on the turntable, or transport it to a specific visitation area.

Prior to allowing the SRM to move a casket to a visitation area or to the turntable, a programmed logic controller (PLC) of the FMS will be instructed to open the associated interior (i.e., the second, interment) door. The exterior (i.e., the first, visitor) door must be confirmed as fully closed before the interior door will be instructed to open. After the interior door has been confirmed as fully opened, the SRM will be permitted to place the casket in the respective visitation area. After the casket has been placed in the visitation area, and the satellite (i.e., the interred subject carrier moving on the visitation area railway) has fully retracted, the interior door will be instructed closed by the PLC. If the interior door is confirmed as fully closed, the exterior door will then open.

The PLC will start a timer once the casket is presented to the customer in the visitation area. If the customer does not complete their visit, log out using the EAP, and exit the visitation area prior to a scheduled period of time (e.g., 60 minutes), a chime will sound (or a chime will sound if another customer is awaiting the visitation area). An attendant will be able to check for anomalies via closed-circuit television (CCTV) and infra-red (IR) detectors/monitors.

In one embodiment, the IR detector will provide alarm to the PLC if a high delta-T condition is detected. The PLC will pass this alarm condition to the FMS. A high delta-T condition will inhibit the closing of the exterior door, and a re-storing of the casket. An overweight or out of balance condition (e.g., 20% or 50 lbs on one side of the centerline) will inhibit closing the exterior door, will notify the attendant, and will notify the customer (visitor) via an audible alarm with message on the EAP. Then the customer will use the EAP to close the exterior door by indicating that they have completed their visit. The FMS will transmit a message to the PLC, requesting closure of the exterior door. The PLC will close the door. When the exterior door is confirmed fully closed, the PLC will provide opening of the interior door.

When the interior door is confirmed fully opened, the PLC will transmit a message indicating that the casket of the interred subject is ready for re-storing (transport back to the interment area). The FMS will command the SRM to pick up the enclosure of the interred subject, and transport it to an appropriate storage location (e.g., interment bay). When the SRM has removed the enclosure, and the satellite of the respective visitation area railway has fully retracted, the PLC will instruct closure of the interior door. When the SRM has successfully stored the interred subject, a completed mission report will be acknowledged by the FMS.

### Example 2

In an embodiment employing a double interred subject viewing area, operation is similar to the single interred subject visitation scenario. When a customer arrives, if the double viewing is unoccupied, the customer may reserve and use the area. The customer will enter their credentials using the EAP located adjacent to the double viewing area access door. If the credentials are incorrect, and/or do not match those stored within the FMS, the following message will be provided. The credentials that were entered are incorrect. Please re-enter them or see the attendant for assistance. If the customer's credentials are accepted, a request is initiated to move the caskets.

The PLC will confirm that the viewing area access door is fully closed and that the IR detector shows no signs in the viewing access area. After the PLC confirms, the PLC will allow the SRM to deliver the caskets to the double viewing area. The delivery process can include rotating and/or squaring the casket (i.e., correcting orientation prior to transport to the visitation area). The FMS will essentially execute the same procedure as for the single interred subject viewing stations, and deliver the caskets to the double viewing visitation area. After the caskets have been delivered to the double viewing area, the system will allow the customer to open the viewing area access door via the EAP.

After the customer(s) have completed their visit, he/she will exit and close the viewing area door via the EAP. The PLC will report the container weights to the FMS. The FMS will evaluate the weights, whether they have exceeded the high limit, or whether they are out of balance. If the IR detector, located above the respective visitation area, detects activity (heat) in the area, the exterior door will not close. If the condition exists for a certain period of time, an attendant will be notified. After the condition is cleared, the door is closed, and the PLC will notify the FMS that the caskets are available to re-store. If the gross weight limit is exceeded, or the casket is out of balance, the FMS will not accept the casket for storage and the attendant will be notified. The FMS will instruct the SRM to return the caskets to a specific storage location in the interment area.

Additionally, interment and retrieval activities could further implement an automatic time designation within the control system of the FMS. This embodiment allows the interred subject to be moved to a visitation area without being initiated by mourners physically arriving at the facility. Specifically, it is understood that with the transient nature of today's society, a family member living great distances from the interment facility might want the interred subject to be occasionally moved to a particular garden area, or avian facility. More specifically, family members of an interred subject may desire that the interred subject occasionally or routinely be re-located to, and be exposed to (for a period of time): 1) an indoor interment facility location having windows to the outdoors, to the garden area, or to the avian facility (thereby, family members would know that the interred subject was experiencing a setting of sunshine and flowers; 2) the garden area or avian facility within the interment facility; or 3) a comfortable setting in which to be involved with a desired event (e.g. the Super Bowl, a Thanksgiving parade), which were once shared between the family member and the interred subject.

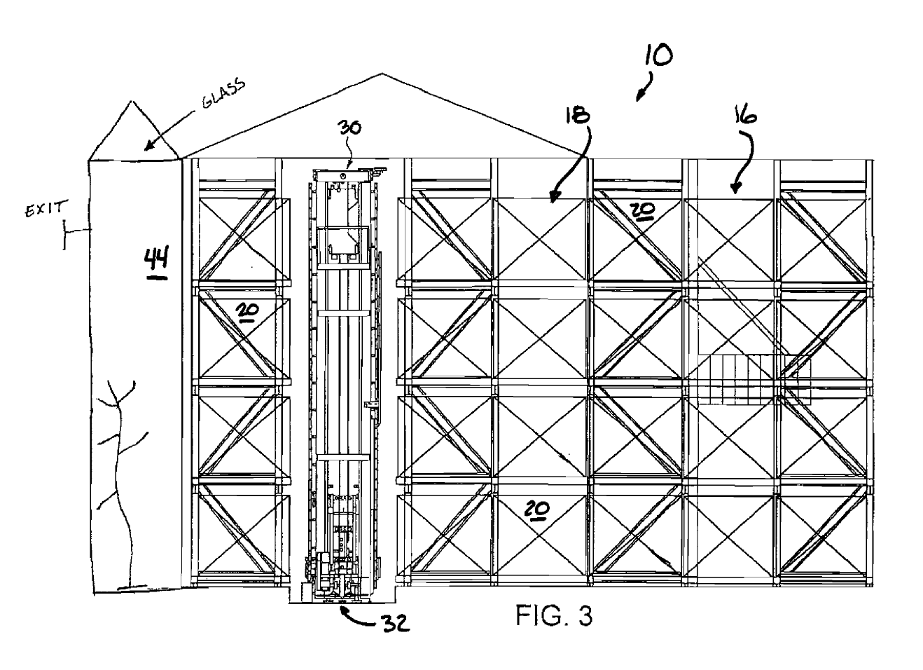

In another embodiment, the present invention is directed to a interment facility, with accompanying habitat facility, for interment and for the automated retrieval of the interred subject for their visitation to the accompanying habitat facility, and for the development of the habitat facility (e.g., a garden or avian sanctuary). Referring to FIG. 3, a habitat facility 44 is illustrated which is designed and built to accompany the interment area 16 of a interment facility 10, for interment and automated retrieval of interred subjects 20, for the visitation of the habitat facility 44 by the interred subject 20, as well as a sanctuary for the development of the desired habitat (with no visitor occupancy). The interment facility 10 that includes the habitat facility 44, also includes an interment area 16, and a system retrieval mechanism for transporting a selected one of the interred subjects 20 between the interment area 16 and the habitat facility 44. The interment facility 10 of this embodiment may also include one or more visitation areas, and/or one or more double interred subject visitation areas. In alternative embodiments, areas of the habitat facility, or the habitat facility itself, could serve as a visitation area for family members and interred subjects.

Inclusion of the habitat facility, in the interment facility, takes advantage of the requirements of each component of the interment facility, while keeping within the spirit of efficient land use. Specifically, the design combination allows the visitation area to be accessible from the interment area, allowing automated transport of the interred subjects for visitation, while preventing access from the habitat facility (e.g., if an avian sanctuary) into the interment area. In the avian sanctuary embodiment, an extensive vertical height could provide that the height of the interment area and the habitat facility are greater than a land-based length or width. Accordingly, this design allows the vertical height of the habitat facility to preserve more foot-print for interment, while still satisfying the requirements of the habitat facility. Moreover, inhabitants of the habitat facility (e.g., an avian facility) will add to the scenic environment of the interment facility, for peaceful and soothing visitation by family members.

Embodiments of the present invention, where the interment facility is accompanied by a habitat facility, can be very similar in structure and function to the interment facility embodiments including one or more visitation areas (or, as described, the interment facility could include both visitation areas and habitat facilities, and/or visitation areas in habitat facilities. However, in the FIG. 3 embodiment, the interment facility includes a habitat facility not accessible by visitors. In this embodiment, the visitation area(s) is accessible by visitors, but the interment area and habitat facility are not. Thus, the closed and secure interment area is not accessed, and eliminating accessibility to the habitat facility, by visitors to the interment facility, preserves and protects any inhabitants of the habitat facility. Therefore, both the interred subjects and inhabitants of the habitat facility are benefited, while land is also preserved for the good of all. The habitat facility can be predominantly transparent to sunlight, for development of the species therein, and also to add to the aesthetic beauty of the overall facility and surrounding grounds.

Because many varying and different embodiments may be envisioned within the scope of the invention herein taught, and because many modifications may be made in the embodiments herein detailed in accordance with the descriptive requirements of the law, it is to be understood that the details herein are to be interpreted as illustrative and not in a limiting sense.

What is claimed is:

1. An interment facility for interment and the automated retrieval and visitation of interred subjects comprising:
an interment area for holding of interred subjects;
at least one visitation area for visitor access to a selected one of the interred subjects; and
a system retrieval mechanism for transporting the selected one of the interred subjects between the interment area and the at least one visitation area.

2. The interment facility of claim 1, further comprising:
a rack system within the interment area providing a plurality of interment bays for holding the interred subjects;
a track system supporting and providing transport for the system retrieval mechanism; and
a turntable system, accessible to the track system, providing for desired orientation of the selected one of the interred subjects prior to transport of the selected one of the interred subjects from the interment area to the at least one visitation area by the system retrieval mechanism.

3. The interment facility of claim 1, wherein the at least one visitation area has a first door that is traversed by visitors and a second door that is traversed by the selected one of the interred subjects transported from the interment area.

4. The interment facility of claim 3, further comprising a facility management system that controls visitor access through the first door and controls traversal of the selected one of the interred subjects from and to the interment area through the second door.

5. The interment facility of claim 1, further comprising a facility management system, including a tracking system that monitors a location and orientation of the selected one of the interred subjects during transport of the selected one of the interred subjects from the interment area to the at least one visitation area.

6. The interment facility of claim 1, further comprising a facility management system, including a control system that initiates storage of location and orientation information of the interred subjects to determine efficient interment and retrieval of the interred subjects.

7. The interment facility of claim 1, further comprising a facility management system that initiates transport of the selected one of the interred subjects, from the interment area to the at least one visitation area, based on information programmed by a visitor, either at a designated location of the interment facility, or at a location remote to the interment facility.

8. The interment facility of claim 7, wherein facility management system further initiates decoration of the at least one visitation area, based upon a theme selected by the visitor, upon the information programming by the visitor.

9. The interment facility of claim 1, further comprising a habitat facility, wherein, upon customer programmed selection, the system retrieval mechanism transports a selected one of the interred subjects between the interment area and the habitat facility for visitation of the habitat facility, by the interred subject without visitor.

10. The interment facility of claim 9, wherein the visitation area is accessible by visitor, and wherein the interment area and habitat facility are not accessible by visitor.

11. A method for interment and for the automated retrieval and visitation of interred subjects in a interment facility, wherein the facility comprises:
an interment area for holding of interred subjects;
at least one visitation area for visitor access to a selected one of the interred subjects; and
a system retrieval mechanism that transports the selected one of the interred subjects between the interment area and the at least one visitation area;
a facility management system that controls automated transport of the selected one of the interred subjects between the interment area and the at least one visitation area; and
the method comprises the steps of:
depositing an interred subject in the interment area, and recording a location of the interred subject in a control system of the facility management system;
assigning identification information to the interred subject, wherein the identification information is located on the interred subject for reading by a sensory system of the facility management system during interment, and during transport of the interred subject by the system retrieval mechanism;
receiving a request by a visitor, programmed into the facility management system, either at a designated location of the interment facility, or at a location remote to the interment facility, for visitation of a selected interred subject, the request including at least the identification information of the selected interred subject, a time of the visitation, and identification of the at least one visitation area; and
retrieving the selected interred subject from the interment area, using the system retrieval mechanism, and transporting the selected interred subject to the identified visitation area.

12. The method of claim 11, further comprising the step of receiving, by programmed entry into the facility management system, at a conclusion of the visitation, the identification information of the interred subject, wherein the facility management system instructs:
performance of a series of safety checks upon the interred subject, by the sensory system, and upon positive completion of the safety checks; and
transportation of the selected interred subject from the identified visitation area to the interment area, using the system retrieval mechanism.

13. The method of claim 11, further comprising the step of, during transport of the selected interred subject from the interment area to the identified visitation area, a monitoring of an orientation of the selected interred subject, and wherein, if the orientation of the selected interred subject does not comply with a pre-programmed visitation orientation, transporting the selected interred subject to a turntable system, prior to transport to the identified visitation area, for adjustment of the orientation of the selected interred subject.
